(19) United States
(12) Patent Application Publication
(10) Pub. No.: US 2019/0027161 A1
(43) Pub. Date: Jan. 24, 2019

(54) METHOD AND SYSTEM FOR FACILITATING DECOMPOSITION OF SOUND SIGNALS

(71) Applicants: Kent E. Lovelace, (US); Michael Sharp, (US)

(72) Inventor: Michael Sharp, Porter, TX (US)

(21) Appl. No.: 16/040,311

(22) Filed: Jul. 19, 2018

Related U.S. Application Data
(60) Provisional application No. 62/534,530, filed on Jul. 19, 2017.

(51) Int. Cl. G10L 25/51; G10L 25/84; G10L 25/27; H04S 7/00

(52) U.S. Cl. CPC G10L 25/51; G10L 25/84; G10L 2025/783; H04S 7/40; G10L 25/27

(57) ABSTRACT

Disclosed is a method of facilitating decomposition of sound signals. The method includes receiving multiple sound signals from multiple communication devices communicatively coupled to multiple sound recording devices. Further, the method includes processing multiple sound signals using at least one sound processing algorithm. Further, the method includes generating multiple sound layers corresponding to multiple sound signals based on the processing. Further, the method includes generating a visualization based on generating multiple sound layers. Further, the method includes transmitting the visualization corresponding to multiple sound layers to a user device. Further, the method includes storing multiple sound layers in association with multiple sound layer identifiers. Further, the method includes receiving a request for a sound layer from the user device. Further, the method includes retrieving the sound layer based on the request including the sound layer identifier. Further, the method includes transmitting the sound layer to the user device.

### FIELD OF THE INVENTION

The present invention relates generally relates to the field of data processing. More specifically, the present disclosure relates to methods and systems for decomposing acoustic signals.

### BACKGROUND OF THE INVENTION

For various applications, there is a need to obtain specific sounds from a compound acoustic signal comprising multiple sounds. Such as, separating musical sounds in a restaurant environment. However, it is often challenging to extract respective source sounds from a compound acoustic signal obtained in a noisy environment. Further, it is difficult to estimate the number of individual source sounds in a specific environment.

Therefore, there is a need for improved methods and systems for decomposing acoustic signals that may overcome one or more of the abovementioned problems and/or limitations.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to an aspect, a system for facilitating decomposition of sound signals is disclosed. The system may include a plurality of sound recording devices located in a plurality of locations of a physical space. Further, each sound recording device may be configured to capture at least one sound in at least one direction. Further, the system may include a plurality of communication devices communicatively coupled to the plurality of sound recording devices. Further, each communication device may be configured to receive a plurality of sound signals from the plurality of sound recording devices and transmit the plurality of sound signals to a central station. Further, the central station may include a central communication device configured for communicating with each of the plurality of communication devices. Further, the central communication device may be configured for transmitting a visualization corresponding to a plurality of sound layers to a user device. Further, the central communication device may he configured for receiving a request for a sound layer from the user device. Further, the request may include a sound layer identifier. Further, the central communication device may be configured for transmitting the sound layer to the user device. Further, the system may include a central processing device communicatively coupled to the central communication device. Further, the central processing device may he configured for processing the plurality of sound signals using at least one sound processing algorithm. Further, the central processing device may be configured for generating a plurality of sound layers corresponding to the plurality of sound signals based on the processing. Further, a sound layer may include a sound corresponding to a distinct source of sound. Further, the plurality of sound layers may be associated with a plurality of sound layer identifiers. Further, the central processing device may be configured for generating the visualization based on generating the plurality of sound layers. Further, the system may include a central storage device communicatively coupled to the central processing device. Further, the central storage device may be configured for storing the plurality of sound layers in association with the plurality of sound layer identifiers. Further, the central storage device may be configured for retrieving the sound layer based on the request including the sound layer identifier.

According to another aspect, a method of facilitating decomposition of sound signals is disclosed. The method may include receiving, using a central communication device, a plurality of sound signals from a plurality of communication devices communicatively coupled to a plurality of sound recording devices. Further, the plurality of sound recording devices may be located in a plurality of locations of a physical space. Further, each sound recording device may be configured to capture at least one sound in at least one direction. Further, the method may include processing, using a central processing device, the plurality of sound signals using at least one sound processing algorithm. Further, the method may include generating, using the central processing device, a plurality of sound layers corresponding to the plurality of sound signals based on the processing. Further, a sound layer may include a sound corresponding to a distinct source of sound. Further, the plurality of sound layers may be associated with a plurality of sound layer identifiers. Further, the method may include generating, using the central processing device, a visualization based on generating the plurality of sound layers. Further, the method may include transmitting, using the central communication device, the visualization corresponding to a plurality of sound layers to a user device. Further, the method may include storing, using a central storage device, the plurality of sound layers in association with the plurality of sound layer identifiers. Further, the method may include receiving a request for a sound layer from the user device. Further, the request may include a sound layer identifier. Further, the method may include retrieving, using the central storage device, the sound layer based on the request including the sound layer identifier. Further, the method may include transmitting the sound layer to the user device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a block diagram of the system for facilitating decomposition of sound signals, in accordance with some embodiments.

FIG. 3 is a flowchart of a method of facilitating decomposition of sound signals, in accordance with some embodiments.

FIG. 4 is a flowchart of a method of merging sound signals, in accordance with some embodiments.

FIG. 5 is a flowchart of a method of producing an acoustic model corresponding to the physical space, in accordance with some embodiments.

FIG. 6 is a flowchart of a method of producing an acoustic model corresponding to the physical space, in accordance with some embodiments.

FIG. 7 is a flowchart of a method of obtaining sound signatures, in accordance with some embodiments.

FIG. 8 is a flowchart of a method of manipulating one or more sound layers, in accordance with some embodiments.

FIG. 9 is a flowchart of a method of transforming one or more sound layers based on an acoustic model, in accordance with some embodiments.

FIG. 10 illustrates multiple waveforms in accordance with an exemplary embodiment.

FIG. 11 illustrates a physical space with a plurality of sound recording devices located in a plurality of locations of the physical space in accordance with an exemplary embodiment.

FIG. 12 illustrates a user interface showing a plurality of visual layers corresponding to the plurality of sound layers, in accordance with an exemplary embodiment.

FIG. 13 is a flowchart of a method for decomposing acoustic signals, in accordance with an exemplary embodiment.

FIG. 14 is a block diagram of a decomposition system for decomposing acoustic signals, in accordance with an exemplary embodiment.

FIG. 15 illustrates sounds emanating in a restaurant environment, in accordance with an exemplary embodiment.

FIG. 16 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure.

Instead, the proper scope of the disclosure is defined by the appended claims. The present disclosure contains headers. It should be understood that these headers are used as references and are not to be construed as limiting upon the subjected matter disclosed under the header.

### Overview

According to some aspects, the present disclosure provides a method for receiving an acoustic signal and decomposing the acoustic signal into a constituent audio object. The method allows for poly-sample captures with discernment of frequency stems and sound layers that can be isolated and manipulated.

According to further aspects, the present disclosure provides algorithms (audagraph algorithms) that may process an audible signal to perform one or more of sampling, slicing, dissecting, saving and storing for retrieval, thus allowing respective content samples to be replicated digitally with added frequency options allowing for remix of the original content to create new content from the source audio.

According to an exemplary embodiment, a restaurant environment may include 100 people having a busy lunch. All sounds in the environment may be captured and stored from various recording devices pre-placed in the environment from angles and multisource recording devices, including personal devices worn and carried by the patrons and restaurant staff for a total audio capture. For example, the sound may be captured using audagraph record edit and storage applications that make up key components in the audagraph algorithms. The stored sound may be utilized for stem frequency mix offering isolated and pinpoint options for perceptible audio created in the room. For example, a conversation between 3 of the restaurant lunch patrons. The entire conversation may be multi-sampled. Once the audio is captured, the content of their conversation may also be a shown in visual transparent layers with each of the three voices IDs and represented by frequency slice along with voice ID of all other audio in total room capture. The technology and the method of layered sample IDs may be utilized to illustrate audio-visually in real time with audagraph algorithms. In another audagraph slice from the same restaurant environment in time, the sounds generated from the silverware and dishes on the table, the three patrons are dining at, show the level of frequency spectrum available for discernment methodology pertaining to frequency slice portions of the algorithms ability to zone in and capture just the sounds attributed to the flatware and dishes generated throughout the lunch audagraph timeline.

According to some aspects, the present disclosure provides an audagraph algorithm technology that may take recordings, such as multitrack music recordings, and slice all the frequencies into discernable layers both visual and audio layers viewable in real time with audagraph and holograph algorithms. Various sounds may include a piano sound, a guitar sound, a bass guitar sound and a rhythm guitar sound. Further, all sounds of the recording may be frequency ID'ed by an audio sample slicer and then may be saved as individual stems may be manipulated or played back in multiple mix scenarios enhanced by frequency remix and digital signal processing.

According to some aspects, the present disclosure provides pre-recorded content obtained via resampling the content at high definition quality. Accordingly, all frequency spectrum is available that may be used to slice the acoustics of the room mix as a layer of audio content and use in future mixes and recordings generating cross pollinating poly-frequencies of the sound spectrum.

The disclosed technology may be used in every field of science where sound or sound reproduction comes into play by. With the discernible frequency sound slice capability, any sound or sound group can be sampled, then layered frequencies identified and labeled for editing and store for future retrieval.

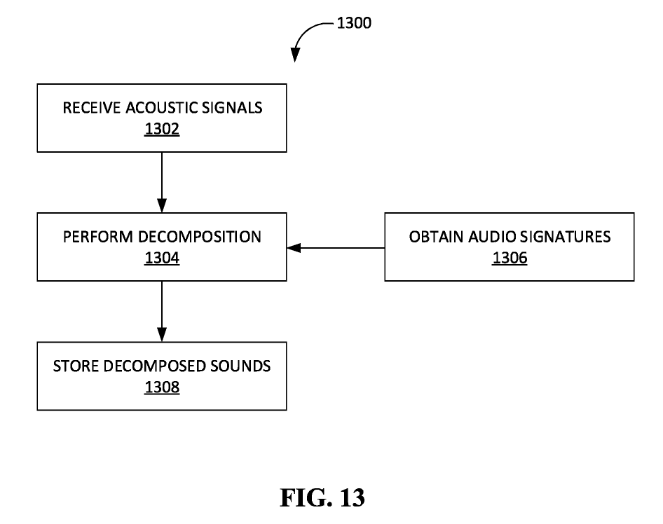

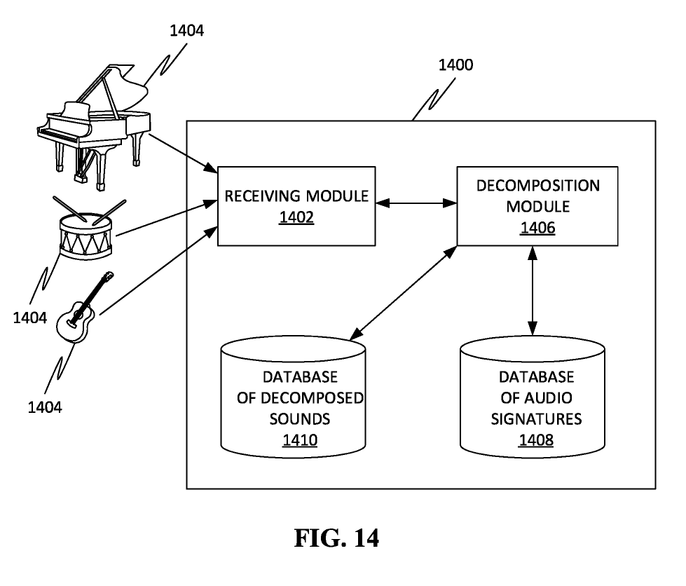

FIG. 13 is a flowchart of a method 1300 for decomposing acoustic signals, in accordance with an exemplary embodiment. FIG. 14 is a block diagram of a decomposition system 1400 for decomposing acoustic signals, in accordance with an exemplary embodiment.

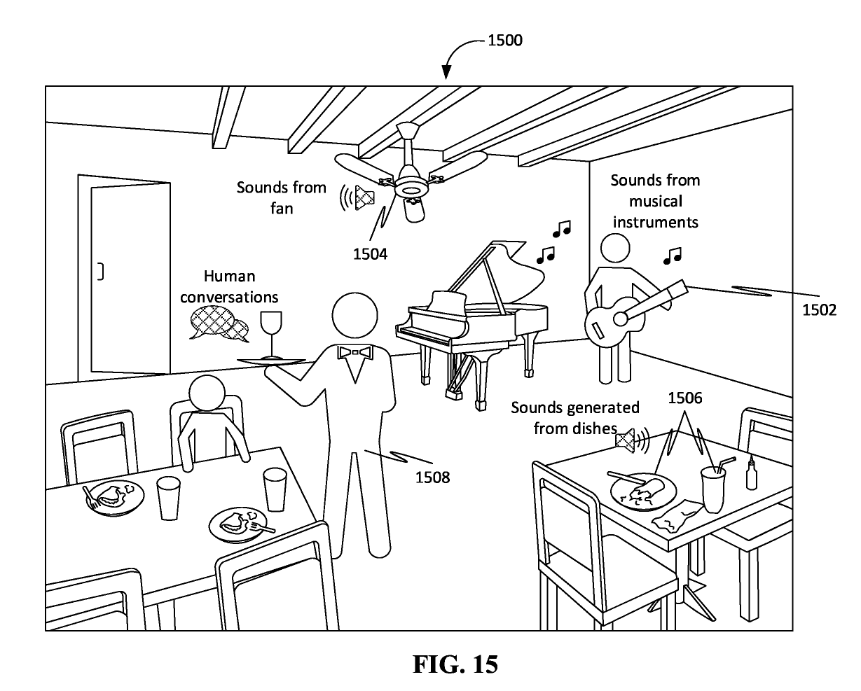

At 1302, an acoustic signal may be received by a receiving module 1402 of the decomposition system 1400. The acoustic signal may comprise sounds from one or more musical instruments 1404. Further, the acoustic signal may be received from a restaurant environment 1500 shown in FIG. 15. For example, the acoustic signal may comprise sounds from one or more sources such as a musical instrument 1502, a fan 1504, dishes 1506 and humans 1508. Accordingly, the acoustic signal may include multiple sounds such as sounds of conversation between the restaurant patrons and restaurant employees, sounds generated from the silverware and dishes on tables, sounds from electrical equipment such as fans, and sounds from musical instruments. One or more recording devices (not shown) in the restaurant environment m1500 may obtain the acoustic signal in the restaurant environment 1500 and send the acoustic signal to the receiving module 1402.

Thereafter, at 1304, a decomposing module 1406 may decompose the acoustic signal into constituent audio objects. For example, the acoustic signal associated with an orchestra may be decomposed into sound objects associated with different musical instruments. Accordingly, in some embodiments, the multitude of sound objects may be presented to the user the form of a visualization. For instance, multiple layers corresponding to multiple instruments of an orchestra may be displayed. Therefore, a user may be able to view the multitude of sound components comprised in an acoustic signal.

Further, at 1306, the decomposition module 1406 may compare the acoustic signal with one or more predetermined audio signatures obtained from a database 1408 of audio signatures. For instance, each sound producing object may be associated with a unique audio signature. For example, a piano may be associated with a unique frequency spectrum. Further, although different kinds of pianos may be characterized by different corresponding audio signatures, in some embodiments, a group audio signature may be determined. In other words, the group audio signature may be common across different kinds of sound generating objects belonging to a common category, such as for example, pianos.

According to some embodiments, the decomposition module may correlate the one or more audio signatures with the acoustic signal in order to determine if the one or more audio signatures are present in the acoustic signal. Further, by performing a correlation based filtering, audio objects corresponding to the one or more audio signatures may be extracted from the acoustic signal.

According to some embodiments, the database 1408 of audio signatures corresponding to the different sound generating objects may be created and maintained. Therefore, the one or more predetermined audio signatures may be obtained by the decomposition module 1406 from the database 1408 of audio signatures.

In some embodiments, the decomposition module 1406 may analyze the acoustic signal in order to determine acoustic characteristics of an environment associated with the acoustic signal. For example, if the acoustic signal was recorded within the restaurant of FIG. 15, the decomposition module 1406 may be able to determine acoustic characteristics of the restaurant by analyzing the acoustic signal.

At 1308, the decomposing module 1406 may decompose the acoustic signal into constituent audio objects and then store the constituent audio objects into a database 1410 of decomposed sounds. The users may access the database 1410 of decomposed sounds to obtain one or more sounds for various purposes. For example, a user may use the decomposition system 1400 to decompose acoustic signal obtained from their bedroom, such that the one or more audio objects related to their bedroom are stored in the database 1410 of decomposed sounds by the decomposition system. Thereafter, the user may access the database 1410 of decomposed sounds to download the one or more audio objects related to their bedroom. The user may take the one or more audio objects on trips away from home. In a hotel room, the user may use headphones or a similar personal listening device to listen to the sounds of their bedroom to have an auditory ambience that they are accustomed to. The access to the normal sounds of their home environment may help the user sleep better.

The present disclosure includes many aspects and features. Moreover, while many aspects and features relate to, and are described in, the context of processing acoustic signals, embodiments of the present disclosure are not limited to use only in this context.

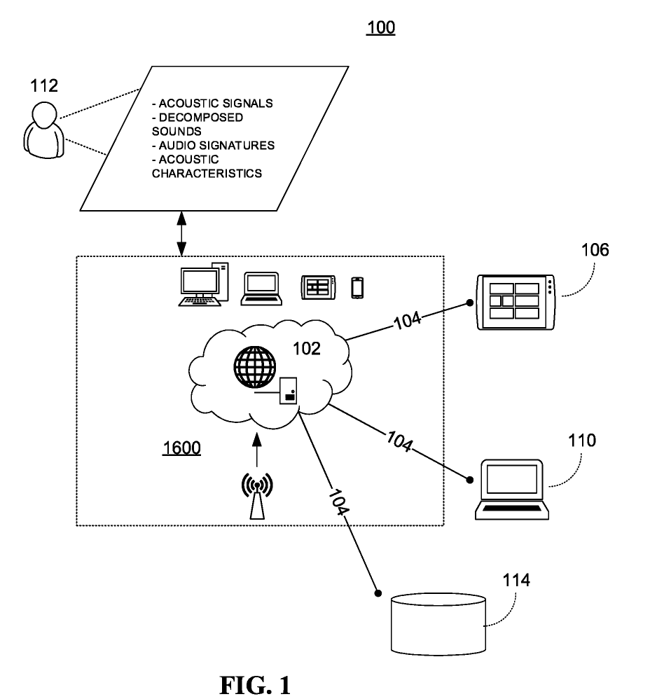

FIG. 1 is an illustration of an online platform 100 consistent with various embodiments of the present disclosure. By way of non-limiting example, the online platform 100 for facilitating decomposition of sound signals may be hosted on a centralized server 102, such as, for example, a cloud computing service. The centralized server 102 may communicate with other network entities, such as, for example, a mobile device 106 (such as a smartphone, a laptop, a tablet computer etc.) and other electronic devices 110 (such as desktop computers, server computers etc.) over a communication network 104, such as, but not limited to, the Internet. Further, users of the platform may include relevant parties such as one or more of individuals, sound artists and administrators and so on. Further, the centralized server 102 may communicate with one or more external databases 114 (such as a database of decomposed sounds and a database of audio signatures). Accordingly, electronic devices operated by the one or more relevant parties may be in communication with the platform 100. For example, the mobile device 106 may be operated by an individual to obtain one or sounds of their bedroom.

A user 112, such as the one or more relevant parties, may access the platform 100 through a software application. The software application may be embodied as, for example, but not be limited to, a website, a web application, a desktop application, and a mobile application compatible with a computing device 1600.

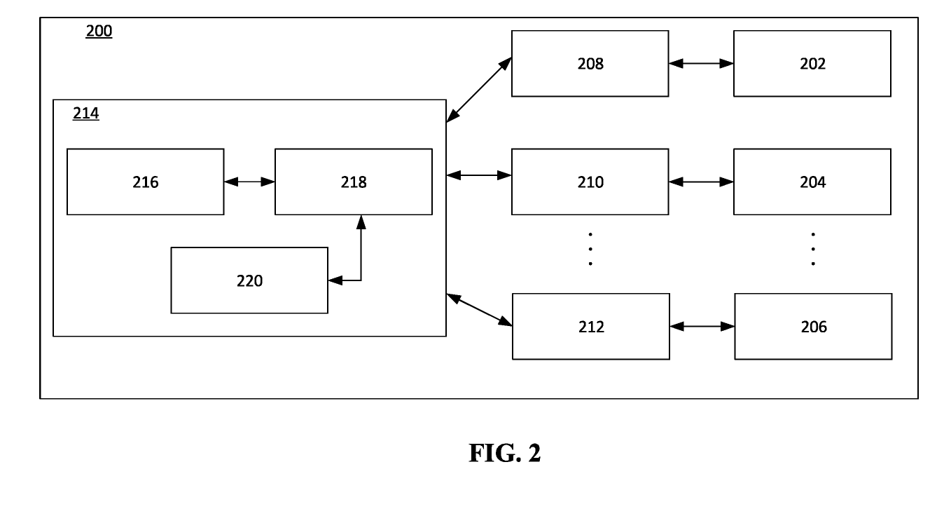

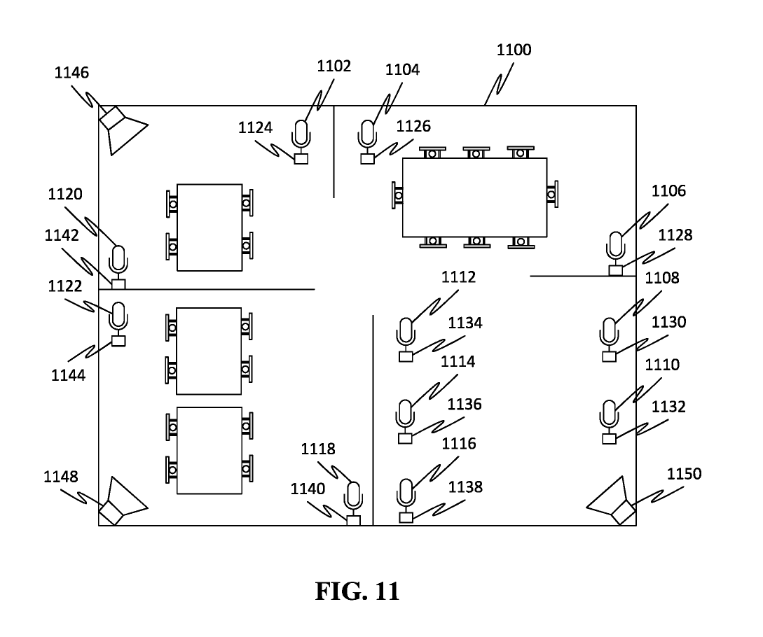

According to some embodiments, the online platform 100 may communicate with a system 200 for facilitating decomposition of sound signals. FIG. 2 is a block diagram of the system 200 for facilitating decomposition of sound signals, in accordance with some embodiments. The system 200 may include a plurality of sound recording devices 202-206 located in a plurality of locations of a physical space. For example, the physical space may be an indoor environment such as a home, an office, a restaurant etc. and/or an outdoor environment such as a street, a public park, etc. Further, each sound recording device may be configured to capture at least one sound in at least one direction. In some embodiments, the plurality of locations corresponds to positions within the physical space where sounds emanating from the physical space may be captured. For example, the plurality of locations may correspond to a plurality of tables in a restaurant. This is explained in detail in conjunction with FIG. 11 below.

In general, the plurality of sound recording devices 202-206 may include any device capable of capturing acoustic waves in one or more mediums (e.g. a gaseous medium, a liquid medium and a solid medium) and converting the information in the acoustic waves into electrical and/or optical signals. In an instance, a sound recording device (in the plurality of sound recording devices 202-206) may include a microphone configured to convert acoustic waves arranged on the microphone into sound signals representing information embodied in the acoustic waves. In some embodiments, the plurality of sound recording devices 202-206 may be stationary. Accordingly, the plurality of sound recording devices 202-206 may be configured to be disposed in a plurality of locations. Further, the plurality of sound recording devices 202-206 may include disposing means such as, for example, attachment means, to facilitate disposing of the plurality of sound recording devices 202-206 at the plurality of locations. Alternatively, in some embodiments, the plurality of sound recording devices 202-206 may be mobile. For example, in an instance, the plurality of sound recording devices 202-206 may be comprised in a plurality of mobile phones. Further in some embodiments, the plurality of sound recording devices 202-206 may be comprised in mobile devices such as robots, drones, etc. Accordingly, in some embodiments, the mobile devices may be configured to receive a command from a remote controller and move to a designated location and/or move along a designated path. As a result, a location and/or path of travel of the plurality of sound recording devices 202-206 may be remotely controlled.

Further, the system 200 may include a plurality of communication devices 208-212 communicatively coupled to the plurality of sound recording devices 202-206. Further, each communication device may be configured to receive a plurality of sound signals from the plurality of sound recording devices 202-206 and transmit the plurality of sound signals to a central station 214. In some embodiments, the plurality of communication devices 208-212 may include wireless communication devices configured to transmit the plurality of sound signals over one or more wireless communication channels such as, but not limited to, Bluetooth, Wi-Fi, cellular communication, satellite communication and so on. In some other embodiments, the plurality of communication devices 208-212 may include wired communication devices. Accordingly, in an instance, the plurality of sound recording devices 202-206 may be connected to a central communication device 216 using cables.

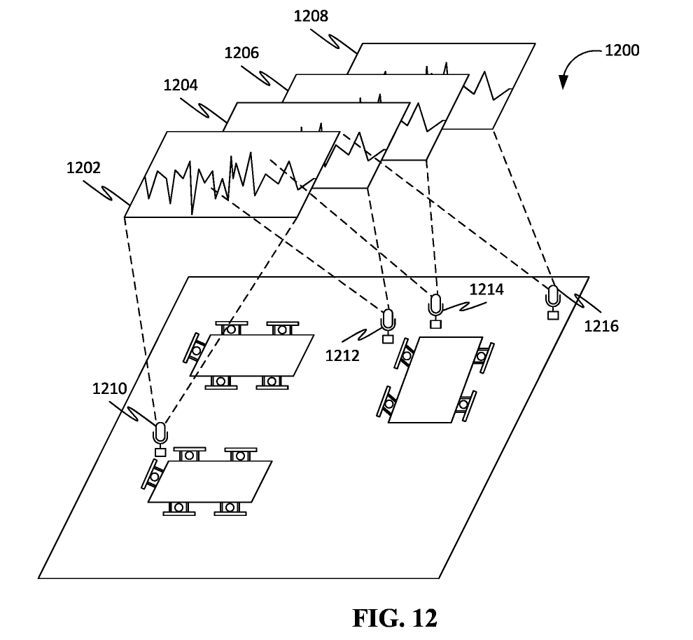

Further, the central station 214 may include the central communication device 216 configured for communicating with each of the plurality of communication devices 208-212. Further, the central communication device 216 may be configured for transmitting a visualization corresponding to a plurality of sound layers to a user device. This is explained in further detail in conjunction with FIG. 12 below. Further, the central communication device 216 may be configured for receiving a request for a sound layer from the user device. Further, the request may include a sound layer identifier. Further, the central communication device 216 may be configured for transmitting the sound layer to the user device.

In general, the visualization may include any graphical form of representing the plurality of sound layers, as shown in FIG. 12 below. For example, the visualization may include a time-based representation of acoustic amplitude corresponding to each of the plurality of sound layers. Alternatively, the visualization may include a frequency-based of presentation of acoustic frequencies corresponding to each of the plurality of sound layers. Further, in some embodiments, the visualization may be based on both a time-based representation and a frequency-based representation. Additionally, in some embodiments, the visualization may include a plurality of visual artefacts corresponding to the plurality of sound layers. Further, the plurality of visual artefacts may be visually discernible. Accordingly, one or more visual characteristic such as, but not limited to, shape, color, pattern, size etc. corresponding to the plurality of visual artefacts may be distinct. As a result, a user viewing the visualization may be able to distinguish a first visual artefact from a second visual artefact. Further, in some embodiments, the visualization may include a representation of one or more of the plurality of sound recording devices 202-206, the plurality of locations, the physical space and one or more objects present in the physical space. For instance, each of the plurality of sound layers may be depicted as emanating from a corresponding source in relation to the physical space. Accordingly, an intuitive interface may be provided to the user in order to understand the different sources of sounds and their corresponding locations in the physical space.

Further, in some embodiments, the visualization may be interactive. Accordingly, a user may be enabled to provide a manipulation input in relation to one or more portions of the visualization. Accordingly, based on the manipulation input and updated visualization may be generated and presented to the user. For example, the user may be enabled to perform a grasp operation on a first sound layer and a second sound layer and subsequently perform a mix operation by merging the first sound layer and the second sound layer together. Accordingly, a third sound layer may be generated based on combining the first sound layer and the second sound layer. Additionally, in some embodiments, the manipulation input may include a specification and/or a change of one or more parameters associated with a sound layer. The one or more parameters may include, but are not limited to, amplitude, frequency, phase, loudness, special effects, filtering, noise cancellation, noise addition, and so on.

Further, the system 200 may include a central processing device 218 communicatively coupled to the central communication device 216. Further, the central processing device 218 may be configured for processing the plurality of sound signals using at least one sound processing algorithm. For example, the at least one sound processing algorithm may include a source separation algorithm. Further, the central processing device 218 may be configured for generating a plurality of sound layers corresponding to the plurality of sound signals based on the processing. Further, a sound layer may include a sound corresponding to a distinct source of sound. Further, the plurality of sound layers may be associated with a plurality of sound layer identifiers. Further, the central processing device 218 may be configured for generating the visualization based on generating the plurality of sound layers.

Further, the system 200 may include a central storage device 220 communicatively coupled to the central processing device 218. Further, the central storage device 220 may be configured for storing the plurality of sound layers in association with the plurality of sound layer identifiers. Further, the central storage device 220 may be configured for retrieving the sound layer based on the request including the sound layer identifier.

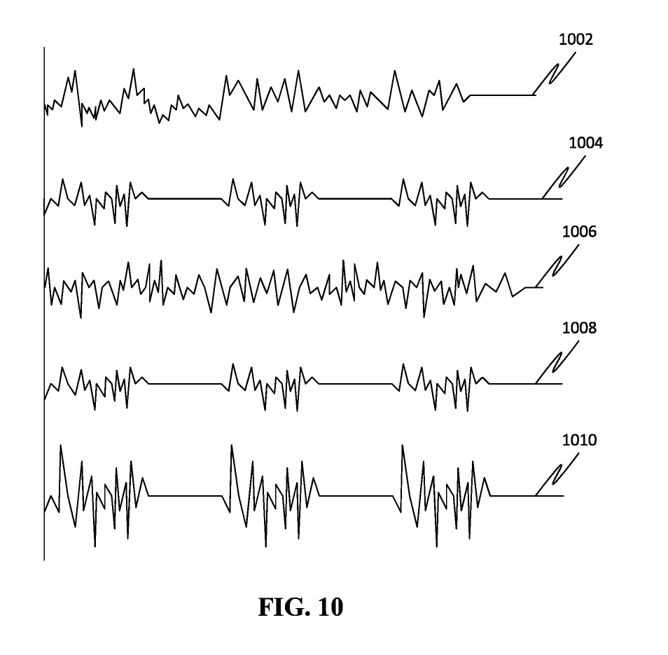

In some embodiments, processing the plurality of sound signals using the at least one sound processing algorithm may include analyzing each of the plurality of sound signals, determining at least one sound characteristic corresponding to each of the plurality of sound signals based on the analyzing and combining at least two sound signals of the plurality of sound signals into a combined sound signal based on the at least one sound characteristic of each of the at least two sound signals being within a predetermined threshold. This is explained in further detail in conjunction with FIG. 10 below.

FIG. 10 illustrates waveforms 1002-1010 in accordance with an exemplary embodiment. The waveform 1002 corresponds to a first sound signal received from a first source (such as a first microphone). The at least one sound processing algorithm may be used to analyze the first sound signal to determine a first sound characteristic represented using the waveform 1004. Further, the waveform 1006 corresponds to a second sound signal received from a second source (such as a second microphone). The at least one sound processing algorithm may be used to analyze the second sound signal to determine a second sound characteristic represented using the waveform 1008. The first sound characteristic (the waveform 1004) and the second sound characteristic (the waveform 1008) are similar which indicates that they correspond to the same sound. Accordingly, the first sound characteristic and the second sound characteristic may be combined to obtain a combined sound signal represented using the waveform 1010.

In some embodiments, processing the plurality of sound signals using the at least one sound processing algorithm further may include synchronizing the at least two sound signals based on timestamps associated with the at least two sound signals. Further, each sound signal of the plurality of sound signals may be associated with a timestamp corresponding to capturing of the at least one sound by the plurality of sound recording devices 202-206.

In some embodiments, the central communication device 216 may be configured to receive at least one physical characteristic corresponding to the physical space and the plurality of locations. Further, the central processing device 218 may be configured for generating an acoustic model corresponding to the physical space. Further, the acoustic model may include at least one acoustic characteristic associated with the physical space. Further, the processing of the plurality of sound signals using the at least one sound processing algorithm may be based on the acoustic model.

In some embodiments, processing the plurality of sound signals using the at least one sound processing algorithm may include comparing a sound signal with a plurality of predetermined sound signatures associated with a plurality of predetermined sound sources. Further, the generating of the plurality of sound layers may be based on a result of the comparing. Further, the central storage device 220 may be configured for retrieving the plurality of predetermined sound signatures.

In further embodiments, the central communication device 216 may be configured to receive at least one physical characteristic corresponding to the physical space and the plurality of locations. Further, the central processing device 218 may be configured for generating an acoustic model corresponding to the physical space. Further, the acoustic model may include at least one acoustic characteristic associated with the physical space. Further, the comparing may be based on the acoustic model.

Accordingly, in some embodiments, the sound signal may be transformed according to the acoustic model to obtain a transformed sound signal. Further, the transformed sound signal may then be compared with each of the plurality of predetermined sound signatures. In other words, the plurality of predetermined sound signatures may correspond to a first acoustic model, while the sound signal may correspond to a second acoustic model associated with the physical space and/or the plurality of locations of the plurality of sound recording devices 202-206. Accordingly, prior to comparing, the sound signal may be transformed such that the transformed sound signal corresponds to the first acoustic model. As a result, the reliability and accuracy of sound decomposition may be enhanced.

Further, in some other embodiments, each of the plurality of predetermined sound signatures may be transformed based on the acoustic model to obtain a plurality of transformed predetermined sound signatures. In other words, initially, the plurality of sound signatures may correspond to the first acoustic model, whereas subsequent to transformation based on the second acoustic model, each of the transformed predetermined sound signatures may correspond to the second acoustic model.

In some embodiments, the central processing device 218 may be further configured for generating, a plurality of sound signatures corresponding to the plurality of sound layers. Further, a sound signature corresponding to a sound layer may include at least one sound feature characterizing the sound source. Further, the central storage device 220 may be configured for storing the plurality of sound signatures.

In some embodiments, the central communication device 216 may be further configured for receiving a sound manipulation input from the user device. Further, the sound manipulation input may be associated with at least one sound layer of the plurality of sound layers. Further, the central processing device 218 may be configured for generating a manipulated sound based on the plurality of sound layers and the sound manipulation input. Further, the central processing device 218 may be configured for generating an updated visualization corresponding to the manipulated sound. Further, the central communication device 216 may be configured for transmitting each of the manipulated sound and the updated visualization to the user device.

In some embodiments, each of a sound recording device the plurality of sound recording devices 202-206 and a communication device of the plurality of communication devices 208-212 may be comprised in a mobile phone. Further, the mobile phone may include a location sensor configured to determine a location of the sound recording device.

In some embodiments, the central processing device 218 may be configured for analyzing the plurality of sound signals. Further, the central processing device 218 may be configured for determining an acoustic model corresponding to the physical space based on the plurality of locations. Further, the central processing device 218 may be configured for transforming the plurality of sound layers into a plurality of transformed sound layers based on the acoustic model. Further, a sound characteristic of a transformed sound layer may be independent of the plurality of locations of the plurality of sound recording devices 202-206 and the physical space. Further, the central storage device 220 may be configured for storing the plurality of transformed sound layers.

Although present disclosure illustrates the invention in the context of a plurality of sound recording devices 202-206; however, in some embodiments, the composition of sound signals may be performed on a single sound signal obtained from a single sound recording device. Further, in some embodiments, the composition of sound signals may be performed on a synthetic sound signal that may be generated using a sound synthesizer.

FIG. 11 illustrates a physical space 1100 (a restaurant) with a plurality of sound recording devices 1102-1122 (similar to the plurality of sound recording devices 202-206) located in a plurality of locations of the physical space in accordance with an exemplary embodiment. For example, the plurality of locations may correspond to a plurality of tables in the restaurant. Further, the plurality of sound recording devices 1102-1122 is communicatively coupled to a plurality of communication devices 1124-1144 (similar to the plurality of communication devices 208-212). Further, a plurality of sources of sounds 1146-1150 is located in their corresponding locations in the physical space.

FIG. 12 illustrates a user interface 1200 showing a plurality of visual layers 1202-1208 corresponding to the plurality of sound layers, in accordance with an exemplary embodiment. For example, each visual layer in the plurality of visual layers 1202-1208 may represent a particular sound layer in the plurality of sound layers. Accordingly, each visual layer in the plurality of visual layers 1202-1208 may include a frequency-based of presentation of acoustic frequencies corresponding to the respective sound layer. Further, each of the plurality of visual layers is depicted as emanating from a corresponding source in relation to a physical space (such as the restaurant of FIG. 11). For example, the visual layer 1202 is depicted as emanating from a source 1210. Similarly, the visual layers 1204-1208 are depicted as emanating from multiple sources 1212-1216, respectively.

Further, the user interface 1200 may be an intuitive interface that may assist a user in understanding the different sources of sounds and their corresponding locations in the physical space. For example, the user may drag and drop a first visual layer over a second visual layer using user interface elements provided on the user interface 1200 to combine the acoustic frequencies of the corresponding sound layers and generate a new visual layer representing the combined sound layers.

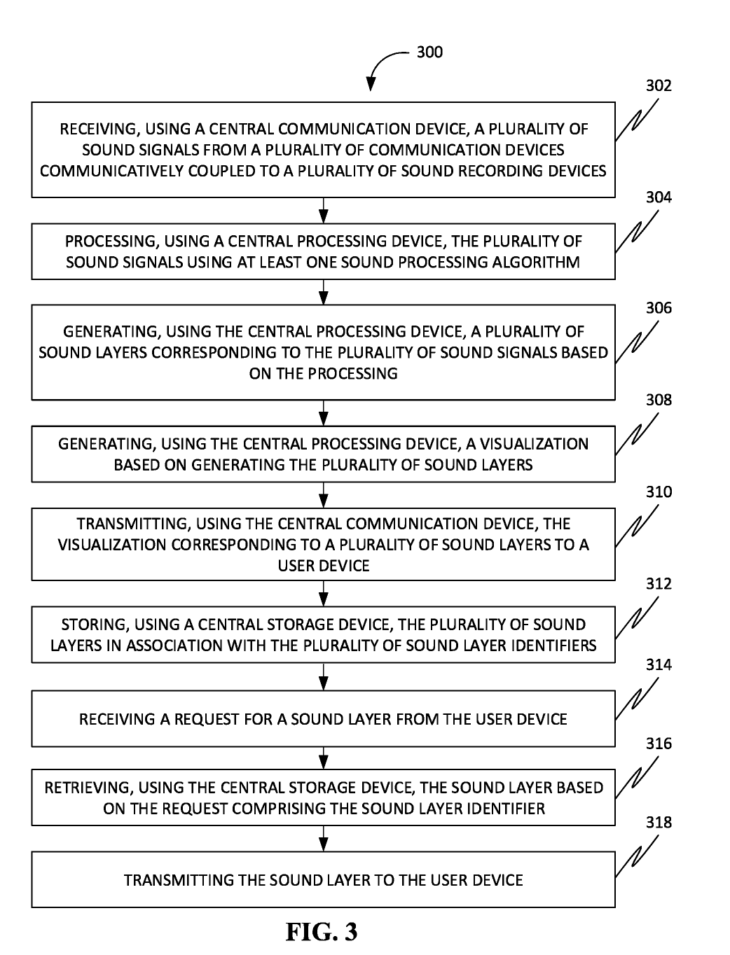

FIG. 3 is a flowchart of a method 300 of facilitating decomposition of sound signals, in accordance with some embodiments. At 302, the method 300 may include receiving, using a central communication device (such as the central communication device 216), a plurality of sound signals from a plurality of communication devices (such as the plurality of communication devices 208-212) communicatively coupled to a plurality of sound recording devices (such as the plurality of sound recording devices 202-206). Further, the plurality of sound recording devices may be located in a plurality of locations of a physical space. For example, the physical space may include an indoor environment such as a home, an office, a restaurant etc. and/or an outdoor environment such as a street, a public park, etc. Further, each sound recording device may be configured to capture at least one sound in at least one direction. In some embodiments, the plurality of locations corresponds to positions within a physical space where sounds emanating from the physical space may be captured. For example, the plurality of locations may correspond to a plurality of tables in a restaurant.

In general, the plurality of sound recording devices may include any device capable of capturing acoustic waves in one or more mediums (e.g. gaseous medium, liquid medium and solid medium) and converting the information in the acoustic waves into electrical and/or optical signals. In an instance, a sound recording device may include a microphone configured to convert acoustic waves arranged on the microphone into sound signals representing information embodied in the acoustic waves. In some embodiments, the plurality of sound recording devices may be stationary. Accordingly, the plurality of sound recording devices may be configured to be disposed in a plurality of locations. Further, the plurality of sound recording devices may include disposing means such as, for example, attachment means, to facilitate disposing of the plurality of sound recording devices at the plurality of locations. Alternatively, in some embodiments, the plurality of sound recording devices may be mobile. For example, in an instance, the plurality of sound recording devices may be comprised in a plurality of mobile phones. Further in some embodiments, the plurality of sound recording devices may be comprised in mobile devices such as robots, drones, etc. Accordingly, in some embodiments, the mobile devices may be configured to receive a command from a remote controller and move to a designated location and/or move along a designated path. As a result, a location and/or path of travel of the plurality of sound recording devices may be remotely controlled.

In some embodiments, the plurality of communication devices may include wireless communication devices configured to transmit the plurality of sound signals over one or more wireless communication channels such as, but not limited to, Bluetooth, Wi-Fi, cellular communication, satellite communication and so on. In some other embodiments, the plurality of communication devices may include wired communication devices. Accordingly, in an instance, the plurality of sound recording devices may be connected to the central communication device using cables.

Further, at 304, the method 300 may include processing, using a central processing device (such as the central processing device 218), the plurality of sound signals using at least one sound processing algorithm. In some embodiments, the at least one sound processing algorithm may include a source separation algorithm.

At 306, the method 300 may include generating, using the central processing device, a plurality of sound layers corresponding to the plurality of sound signals based on the processing. Further, a sound layer may include a sound corresponding to a distinct source of sound. Further, the plurality of sound layers may be associated with a plurality of sound layer identifiers.

At 308, the method 300 may include generating, using the central processing device, a visualization based on generating the plurality of sound layers. In general, the visualization may include any graphical form of representing the plurality of sound layers. For example, the visualization may include a time-based representation of acoustic amplitude corresponding to each of the plurality of sound layers. Alternatively, the visualization may include a frequency-based of presentation of acoustic frequencies corresponding to each of the plurality of sound layers. Further, in some embodiments, the visualization may be based on both a time-based representation and a frequency-based representation. Additionally, in some embodiments, the visualization may include a plurality of visual artefacts corresponding to the plurality of sound layers. Further, the plurality of visual artefacts may be visually discernible. Accordingly, one or more visual characteristic such as, but not limited to, shape, color, pattern, size etc. corresponding to the plurality of visual artefacts may be distinct. As a result, a user viewing the visualization may be able to distinguish a first visual artefact from a second visual artefact. Further, in some embodiments, the visualization may include a representation of one or more of the plurality of sound recording devices, the plurality of locations, the physical space and one or more objects present in the physical space. For instance, each of the plurality of sound layers may be depicted as emanating from a corresponding source in relation to the physical space. Accordingly, an intuitive interface may be provided to the user in order to understand the different sources of sounds and their corresponding locations in the physical space.

Further, in some embodiments, the visualization may be interactive. Accordingly, a user may be enabled to provide a manipulation input in relation to one or more portions of the visualization. Accordingly, based on the manipulation input and updated visualization may be generated and presented to the user. For example, the user may be enabled to perform a grasp operation on a first sound layer and a second sound layer and subsequently perform a mix operation by merging the first sound layer and the second sound layer together. Accordingly, a third sound layer may be generated based on combining the first sound layer and the second sound layer. Additionally, in some embodiments, the manipulation input may include a specification and/or a change of one or more parameters associated with a sound layer. The one or more parameters may include, but are not limited to, amplitude, frequency, phase, loudness, special effects, filtering, noise cancellation, noise addition, and so on.

At 310, the method 300 may include transmitting, using the central communication device, the visualization corresponding to a plurality of sound layers to a user device. At 312, the method 300 may include storing, using a central storage device (such as the central storage device 220), the plurality of sound layers in association with the plurality of sound layer identifiers. At 314, the method 300 may include receiving a request for a sound layer from the user device. Further, the request may include a sound layer identifier. At 316, the method 300 may include retrieving, using the central storage device, the sound layer based on the request including the sound layer identifier. At 318, the method 300 may include transmitting the sound layer to the user device.

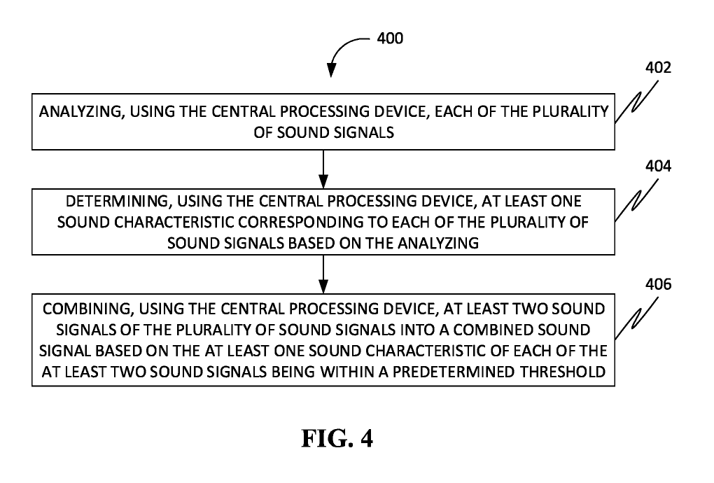

FIG. 4 is a flowchart of a method 400 of merging sound signals, in accordance with some embodiments. At 402, the method 400 may include analyzing, using the central processing device, each of the plurality of sound signals. At 404, the method 400 may include determining, using the central processing device, at least one sound characteristic corresponding to each of the plurality of sound signals based on the analyzing. At 406, the method 400 may include combining, using the central processing device, at least two sound signals of the plurality of sound signals into a combined sound signal based on the at least one sound characteristic of each of the at least two sound signals being within a predetermined threshold.

In some embodiments, processing the plurality of sound signals using the at least one sound processing algorithm further may include synchronizing the at least two sound signals based on timestamps associated with the at least two sound signals. Further, each sound signal of the plurality of sound signals may be associated with a timestamp corresponding to capturing of the at least one sound by the plurality of sound recording devices.

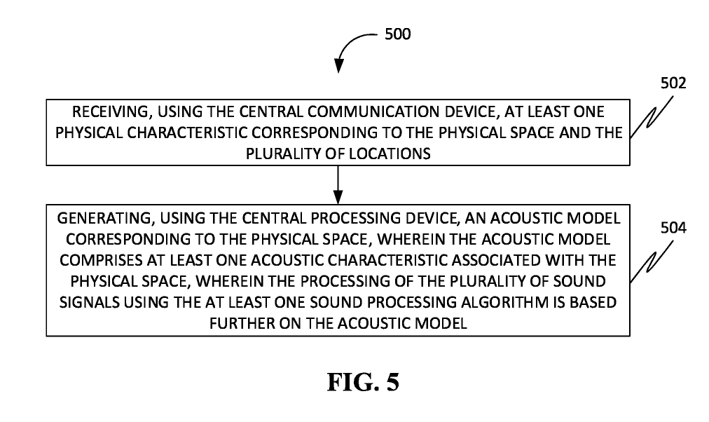

FIG. 5 is a flowchart of a method 500 of producing an acoustic model corresponding to the physical space, in accordance with some embodiments. At 502, the method 500 may include receiving, using the central communication device, at least one physical characteristic corresponding to the physical space and the plurality of locations. At 504, the method 500 may include generating, using the central processing device, an acoustic model corresponding to the physical space. Further, the acoustic model may include at least one acoustic characteristic associated with the physical space. The processing of the plurality of sound signals using the at least one sound processing algorithm may be based further on the acoustic model.

In some embodiments, processing the plurality of sound signals using the at least one sound processing algorithm may include comparing a sound signal with a plurality of predetermined sound signatures associated with a plurality of predetermined sound sources. Further, the generating of the plurality of sound layers may be based on a result of the comparing. Further, the method may include retrieving, using the central storage device, the plurality of predetermined sound signatures.

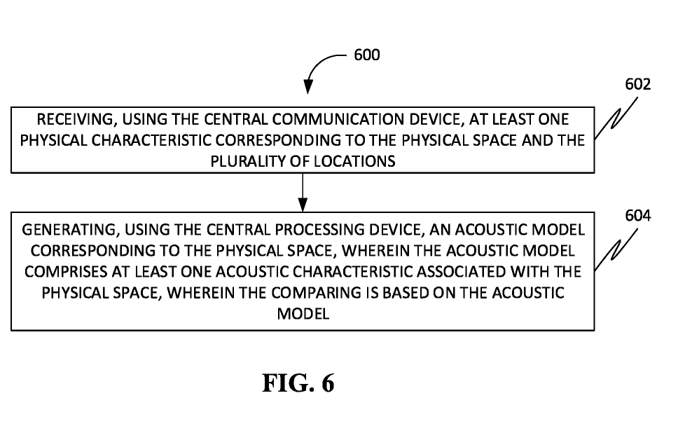

FIG. 6 is a flowchart of a method 600 of producing an acoustic model corresponding to the physical space, in accordance with some embodiments. At 602, the method 600 may include receiving, using the central communication device, at least one physical characteristic corresponding to the physical space and the plurality of locations. At 604, the method 600 may include generating, using the central processing device, an acoustic model corresponding to the physical space. Further, the acoustic model may include at least one acoustic characteristic associated with the physical space. Further, the comparing may be based on the acoustic model.

Accordingly, in some embodiments, the sound signal may be transformed according to the acoustic model to obtain a transformed sound signal. Further, the transformed sound signal may then be compared with each of the plurality of predetermined sound signatures. In other words, the plurality of predetermined sound signatures may correspond to a first acoustic model, while the sound signal may correspond to a second acoustic model associated with the physical space and/or the plurality of locations of the plurality of sound recording devices 202-206. Accordingly, prior to comparing, the sound signal may be transformed such that the transformed sound signal corresponds to the first acoustic model. As a result, the reliability and accuracy of sound decomposition may be enhanced.

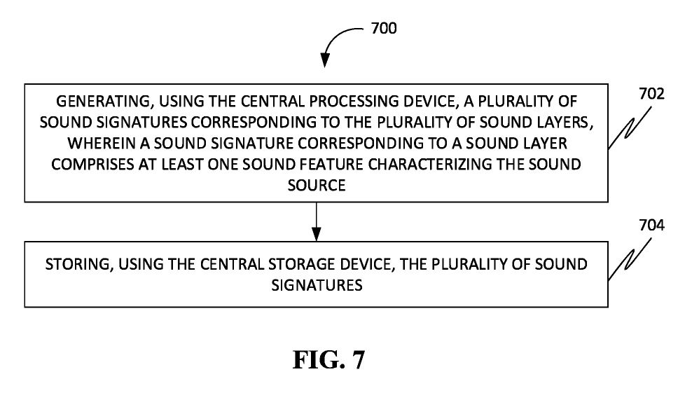

FIG. 7 is a flowchart of a method 700 of obtaining sound signatures, in accordance with some embodiments. At 702, the method 700 may include generating, using the central processing device, a plurality of sound signatures corresponding to the plurality of sound layers. Further, a sound signature corresponding to a sound layer may include at least one sound feature characterizing the sound source. At 704, the method 700 may include storing, using the central storage device, the plurality of sound signatures.

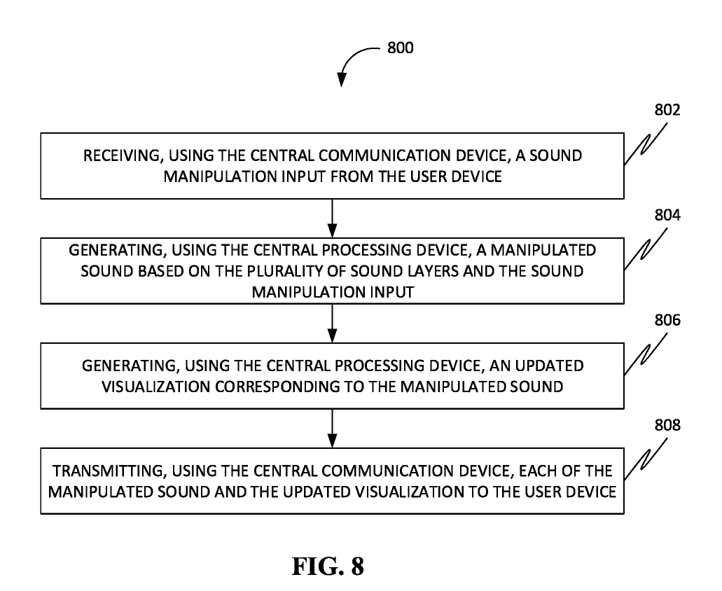

FIG. 8 is a flowchart of a method 800 of manipulating one or more sound layers, in accordance with some embodiments. At 802, the method 800 may include receiving, using the central communication device, a sound manipulation input from the user device. Further, the sound manipulation input may be associated with at least one sound layer of the plurality of sound layers. At 804, the method 800 may include generating, using the central processing device, a manipulated sound based on the plurality of sound layers and the sound manipulation input. At 806, the method 800 may include generating, using the central processing device, an updated visualization corresponding to the manipulated sound. At 808, the method 800 may include transmitting, using the central communication device, each of the manipulated sound and the updated visualization to the user device.

In some embodiments, each of a sound recording device the plurality of sound recording devices and a communication device of the plurality of communication devices may be comprised in a mobile phone. Further, the mobile phone may include a location sensor configured to determine a location of the sound recording device.

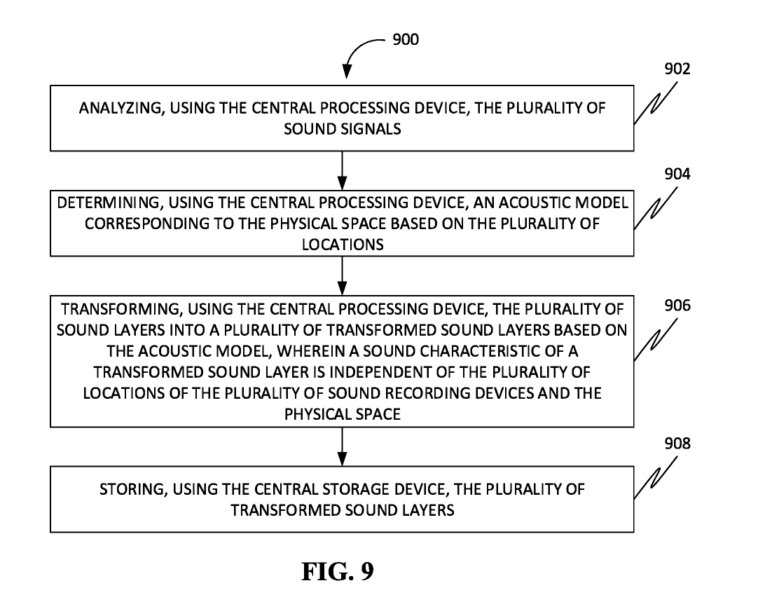

FIG. 9 is a flowchart of a method 900 of transforming one or more sound layers based on an acoustic model, in accordance with some embodiments. At 902, the method 900 may include analyzing, using the central processing device, the plurality of sound signals. At 904, the method 900 may include determining, using the central processing device, an acoustic model corresponding to the physical space based on the plurality of locations. At 906, the method 900 may include transforming, using the central processing device, the plurality of sound layers into a plurality of transformed sound layers based on the acoustic model. Further, a sound characteristic of a transformed sound layer may be independent of the plurality of locations of the plurality of sound recording devices and the physical space. At 908, the method 900 may include storing, using the central storage device, the plurality of transformed sound layers.

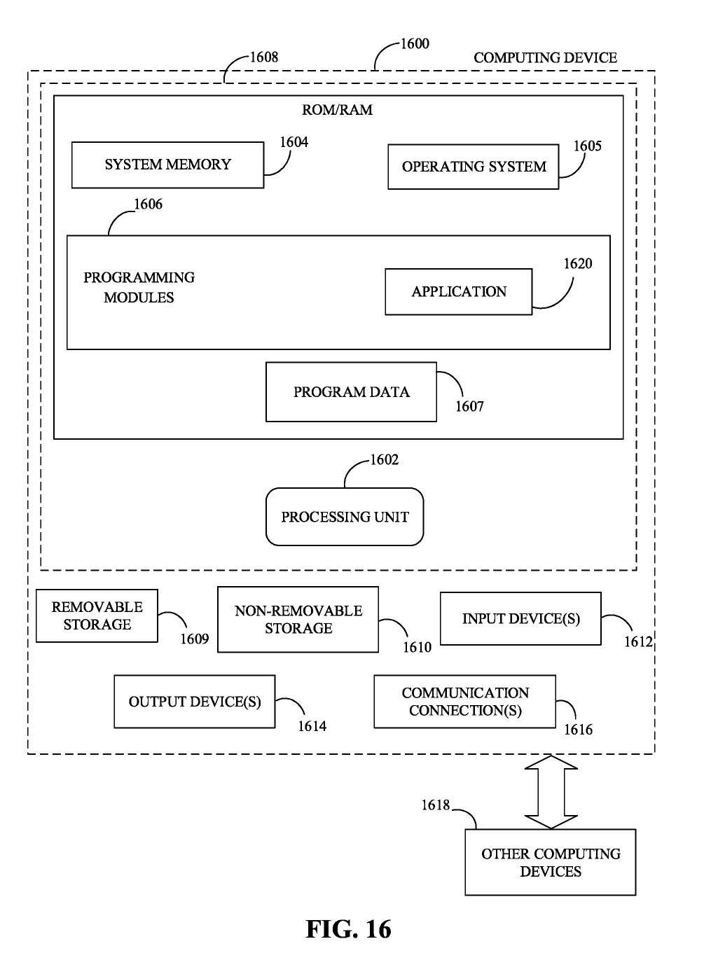

FIG. 16 is a block diagram of a computing device for implementing the methods disclosed herein, in accordance with some embodiments. Consistent with an embodiment of the disclosure, the aforementioned storage device and processing device may be implemented in a computing device, such as computing device 1600 of FIG. 16. Any suitable combination of hardware, software, or firmware may be used to implement the memory storage and processing unit. For example, the storage device and the processing device may be implemented with computing device 1600 or any of other computing devices 1618, in combination with computing device 1600. The aforementioned system, device, and processors are examples and other systems, devices, and processors may comprise the aforementioned storage device and processing device, consistent with embodiments of the disclosure.

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and nonvolatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620) may perform processes including, for example, one or more stages of methods 300-900 and 1300, algorithms, system 200 and 1400, applications, servers, databases as described above. The aforementioned process is an example, and processing unit 1602 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

What is claimed is:

1. A system for facilitating decomposition of sound signals, the system comprising:
a plurality of sound recording devices located in a plurality of locations of a physical space, wherein each sound recording device is configured to capture at least one sound in at least one direction; and
a plurality of communication devices communicatively coupled to the plurality of sound recording devices, wherein each communication device is configured to receive a plurality of sound signals from the plurality of sound recording devices and transmit the plurality of sound signals to a central station, wherein the central station comprises:
a central communication device configured for:
communicating with each of the plurality of communication devices;
transmitting a visualization corresponding to a plurality of sound layers to a user device;
receiving a request for a sound layer from the user device, wherein the request comprises a sound layer identifier; and
transmitting the sound layer to the user device;
a central processing device communicatively coupled to the central communication device, wherein the central processing device is configured for:
processing the plurality of sound signals using at least one sound processing algorithm;
generating a plurality of sound layers corresponding to the plurality of sound signals based on the processing, wherein a sound layer comprises a sound corresponding to a distinct source of sound, wherein the plurality of sound layers is associated with a plurality of sound layer identifiers;
generating the visualization based on generating the plurality of sound layers; and
a central storage device communicatively coupled to the central processing device, wherein the central storage device is configured for:
storing the plurality of sound layers in association with the plurality of sound layer identifiers; and
retrieving the sound layer based on the request comprising the sound layer identifier.

2. The system of claim 1, wherein processing the plurality of sound signals using the at least one sound processing algorithm comprises:
analyzing each of the plurality of sound signals;
determining at least one sound characteristic corresponding to each of the plurality of sound signals based on the analyzing; and
combining at least two sound signals of the plurality of sound signals into a combined sound signal based on the at least one sound characteristic of each of the at least two sound signals being within a predetermined threshold.

3. The system of claim 2, wherein processing the plurality of sound signals using the at least one sound processing algorithm further comprises synchronizing the at least two sound signals based on timestamps associated with the at least two sound signals, wherein each sound signal of the plurality of sound signals is associated with a timestamp corresponding to capturing of the at least one sound by the plurality of sound recording devices.

4. The system of claim 1, wherein the central communication device is configured to receive at least one physical characteristic corresponding to the physical space and the plurality of locations, wherein the central processing device is further configured for generating an acoustic model corresponding to the physical space, wherein the acoustic model comprises at least one acoustic characteristic associated with the physical space, wherein the processing of the plurality of sound signals using the at least one sound processing algorithm is based further on the acoustic model.

5. The system of claim 1, wherein processing the plurality of sound signals using the at least one sound processing algorithm comprises comparing a sound signal with a plurality of predetermined sound signatures associated with a plurality of predetermined sound sources, wherein the generating of the plurality of sound layers is based on a result of the comparing, wherein the central storage device is further configured for retrieving the plurality of predetermined sound signatures.

6. The system of claim 5, wherein the central communication device is configured to receive at least one physical characteristic corresponding to the physical space and the plurality of locations, wherein the central processing device is further configured for generating an acoustic model corresponding to the physical space, wherein the acoustic model comprises at least one acoustic characteristic associated with the physical space, wherein the comparing is based on the acoustic model.

7. The system of claim 1, wherein the central processing device is further configured for generating, a plurality of sound signatures corresponding to the plurality of sound layers, wherein a sound signature corresponding to a sound layer comprises at least one sound feature characterizing the sound source, wherein the central storage device is further configured for storing the plurality of sound signatures.

8. The system of claim 1, wherein the central communication device is further configured for receiving a sound manipulation input from the user device, wherein the sound manipulation input is associated with at least one sound layer of the plurality of sound layers;
wherein the central processing device is further configured for:
generating a manipulated sound based on the plurality of sound layers and the sound manipulation input; and
generating an updated visualization corresponding to the manipulated sound, wherein the central communication device is further configured for transmitting each of the manipulated sound and the updated visualization to the user device.

9. The system of claim 1, wherein each of a sound recording device the plurality of sound recording devices and a communication device of the plurality of communication devices is comprised in a mobile phone, wherein the mobile phone further comprises a location sensor configured to determine a location of the sound recording device.

10. The system of claim 1, wherein the central processing device is configured for:
analyzing the plurality of sound signals;
determining an acoustic model corresponding to the physical space based on the plurality of locations; and
transforming the plurality of sound layers into a plurality of transformed sound layers based on the acoustic model, wherein a sound characteristic of a transformed sound layer is independent of the plurality of locations of the plurality of sound recording devices and the physical space, wherein the central storage device is further configured for storing the plurality of transformed sound layers.

11. A method of facilitating decomposition of sound signals, the method comprising:
receiving, using a central communication device, a plurality of sound signals from a plurality of communication devices communicatively coupled to a plurality of sound recording devices, wherein the plurality of sound recording devices is located in a plurality of locations of a physical space, wherein each sound recording device is configured to capture at least one sound in at least one direction;
processing, using a central processing device, the plurality of sound signals using at least one sound processing algorithm;
generating, using the central processing device, a plurality of sound layers corresponding to the plurality of sound signals based on the processing, wherein a sound layer comprises a sound corresponding to a distinct source of sound, wherein the plurality of sound layers is associated with a plurality of sound layer identifiers;
generating, using the central processing device, a visualization based on generating the plurality of sound layers;
transmitting, using the central communication device, the visualization corresponding to a plurality of sound layers to a user device;
storing, using a central storage device, the plurality of sound layers in association with the plurality of sound layer identifiers;
receiving a request for a sound layer from the user device, wherein the request comprises a sound layer identifier;
retrieving, using the central storage device, the sound layer based on the request comprising the sound layer identifier; and
transmitting the sound layer to the user device.

12. The method of claim 11 further comprising:
analyzing, using the central processing device, each of the plurality of sound signals;
determining, using the central processing device, at least one sound characteristic corresponding to each of the plurality of sound signals based on the analyzing; and
combining, using the central processing device, at least two sound signals of the plurality of sound signals into a combined sound signal based on the at least one sound characteristic of each of the at least two sound signals being within a predetermined threshold.

13. The method of claim 11, wherein processing the plurality of sound signals using the at least one sound processing algorithm further comprises synchronizing the at least two sound signals based on timestamps associated with the at least two sound signals, wherein each sound signal of the plurality of sound signals is associated with a timestamp corresponding to capturing of the at least one sound by the plurality of sound recording devices.

14. The method of claim 11 further comprising:
receiving, using the central communication device, at least one physical characteristic corresponding to the physical space and the plurality of locations; and
generating, using the central processing device, an acoustic model corresponding to the physical space, wherein the acoustic model comprises at least one acoustic characteristic associated with the physical space, wherein the processing of the plurality of sound signals using the at least one sound processing algorithm is based further on the acoustic model.

15. The method of claim 11, wherein processing the plurality of sound signals using the at least one sound processing algorithm comprises comparing a sound signal with a plurality of predetermined sound signatures associated with a plurality of predetermined sound sources, wherein the generating of the plurality of sound layers is based on a result of the comparing, wherein the method further comprises retrieving, using the central storage device, the plurality of predetermined sound signatures.

16. The method of claim 15 further comprising:
receiving, using the central communication device, at least one physical characteristic corresponding to the physical space and the plurality of locations; and
generating, using the central processing device, an acoustic model corresponding to the physical space, wherein the acoustic model comprises at least one acoustic characteristic associated with the physical space, wherein the comparing is based on the acoustic model.

17. The method of claim 11 further comprising:
generating, using the central processing device, a plurality of sound signatures corresponding to the plurality of sound layers, wherein a sound signature corresponding to a sound layer comprises at least one sound feature characterizing the sound source; and
storing, using the central storage device, the plurality of sound signatures.

18. The method of claim 11 further comprising:
receiving, using the central communication device, a sound manipulation input from the user device, wherein the sound manipulation input is associated with at least one sound layer of the plurality of sound layers;
generating, using the central processing device, a manipulated sound based on the plurality of sound layers and the sound manipulation input;
generating, using the central processing device, an updated visualization corresponding to the manipulated sound; and
transmitting, using the central communication device, each of the manipulated sound and the updated visualization to the user device.

19. The method of claim 11, wherein each of a sound recording device the plurality of sound recording devices and a communication device of the plurality of communication devices is comprised in a mobile phone, wherein the mobile phone further comprises a location sensor configured to determine a location of the sound recording device.

20. The method of claim 11 further comprising:
analyzing, using the central processing device, the plurality of sound signals;
determining, using the central processing device, an acoustic model corresponding to the physical space based on the plurality of locations; and
transforming, using the central processing device, the plurality of sound layers into a plurality of transformed sound layers based on the acoustic model, wherein a sound characteristic of a transformed sound layer is independent of the plurality of locations of the plurality of sound recording devices and the physical space; and
storing, using the central storage device, the plurality of transformed sound layers.
